(19) United States
(12) Patent Application Publication
(10) Pub. No.: US 2026/0360686 A1
(43) Pub. Date: Nov. 12, 2026

(54) METHOD AND DEVICE FOR MANUFACTURING ELECTRODES FOR BATTERY CELLS

(71) Applicant: PRECITEC OPTRONIK GMBH, Neu-Isenburg (DE)

(72) Inventors: Werner Schreiber, Meine (DE); Steffen Rieger, Rheine (DE); Jens Reiser, Rheinstetten (DE); Thomas Nicolay, Frankfurt (DE); Simon Mieth, Frankfurt am Main (DE)

(21) Appl. No.: 19/477,049

(22) PCT Filed: Apr. 17, 2024
(86) PCT No.: PCT/EP2024/060415

§ 371 Date: Oct. 20, 2025

(30) Foreign Application Priority Data
Apr. 21, 2023 (DE) 10 2023 110 164.1

(51) Int. Cl. H01M 4/04; H01M 4/66; H01M 4/75

(52) U.S. Cl. CPC H01M 4/0404; H01M 4/0409; H01M 4/661; H01M 4/75

(57) ABSTRACT

In a method for manufacturing electrodes for battery cells, a metal foil is guided, lying on a rotating roller, past a first slot die from which a first electrode paste is discharged, thereby coating a front side of the metal foil with the first electrode paste. The metal foil is then quided, without drying the first electrode paste, past a second slot die from which a second electrode paste is discharged, thereby coating a rear side of the metal foil with the second electrode paste. In this process, the metal foil is not supported by a stationary structure. The thickness of the second electrode paste on the rear side of the metal foil is controlled in a feedback control loop, which includes a contactless thickness sensor as a control loop sensor.

### CROSS-REFERENCE TO RELATED APPLICATIONS

This application is a U.S. national stage of International Application No. PCT/EP2024/060415 filed Apr. 17, 2024, which claims the benefit of and priority to earlier filed German Application No. 10 2023 110 164.1 filed Apr. 21, 2023. The entire disclosures of these earlier filed applications are hereby incorporated by reference as if fully set forth herein.

### BACKGROUND

### 1. Field of the Disclosure

The present disclosure relates to a method and device for manufacturing electrodes for battery cells. The electrodes consist of a thin metal foil onto which an electrode paste is applied on both sides using a slot die coating system.

### 2. Description of the Prior Art

Electrodes for lithium-ion battery cells contain metal foils coated on both sides with an electrode paste. If the electrode is the cathode, the metal foil consists of aluminum and typically has a thickness of between approximately 10 and 20 μm. The electrode paste is approximately 70 to 200 μm thick on each side and usually consists of a mixture of the chemically active substance, e.g. a lithium metal oxide, as well as conductive carbon black, a binder, and a solvent.

In the anode, the metal foil is made of copper and is approx. 8 to 15 μm thick. The electrode paste is usually a mixture of graphite, silicon, conductive carbon black, a binder, and a solvent. The thickness of the coating is in the range of 50 to 150 μm on each side.

The electrode paste, which is initially still moist, is applied to the metal foil by means of slot die coating. The metal foil is guided on a roller past a slot die that extends across the entire width of the metal foil. The electrode paste is forced out of the slot die under pressure and pressed against the metal foil, where it adheres to one side. The moist electrode paste is then dried in a dryer.

The homogeneity of the layer thickness is a decisive factor for the quality of the battery cells. Provided that the slot die coating system generates a sufficiently high mass flow at a given conveyor speed of the metal foil, the layer thickness of the electrode paste is equal to the distance between the outlet opening of the slot die and the metal foil.

Since both sides of the metal foil have to be coated, the front side of the metal foil is coated in a first coating pass and the rear side of the metal foil in a second coating pass.

If two slot die coating systems and two dryers are available, the metal foil coated and dried on one side can be transferred directly to the second system after the first coating pass in order to apply the electrode paste to the other side and dry it (process A). In this way, a continuous process can be achieved.

If only one slot die coating system is available, the electrode must be wound onto a reel during the first coating pass and unwound from this reel for the second coating pass (method B).

In both methods A and B, the electrodes have a very homogeneous layer thickness, since in both cases the distance between the slot die and the metal foil guided on the roller is precisely defined and does not change during the process.

Although method A allows approximately twice the throughput compared to method B, it also requires twice the equipment, namely two slot die coating systems and two dryers.

It was therefore proposed to coat the electrode on both sides in a single coating pass in a modified slot die coating system (process C). In such a system, the front side is first coated with the electrode paste in the manner described above. Immediately afterwards, i.e., without drying, the single-sided coated metal foil is guided through a second slot die, which is arranged so that the rear side of the metal foil is coated with the electrode paste. Process C therefore only requires one drying process, which is carried out after the double-sided coating. This is a significant advantage, as the dryers are up to 80 m long and require a corresponding amount of energy for heating.

However, it has been found that the thickness of the coating on the rear side of the metal foil varies, which cannot be tolerated for all quality requirements.

### SUMMARY

An objective of the present disclosure is to provide a method and a device for efficiently manufacturing double-sided coated electrodes for battery cells in a single coating pass. Variations in coating thickness should be kept to a minimum.

A method achieving this object comprises the following steps:
a) a metal foil is guided, lying on a rotating roller, past a first slot die from which a first electrode paste is discharged, thereby coating the front side of the metal foil with the first electrode paste;
b) the metal foil is guided, without drying the first electrode paste, past a second slot die from which a second electrode paste is discharged, thereby coating a rear side of the metal foil with the second electrode paste, without the metal foil being supported by a stationary structure.

According to some aspects of the present disclosure, the thickness of the second electrode paste on the rear side of the metal foil is controlled in a feedback control loop, which has a contactless thickness sensor as a control loop sensor.

Some aspects of the present disclosure are based on the finding that the observed fluctuations in the coating thickness on the rear side of the metal foil are related to the fact that the metal foil cannot be supported at the coating site with its front side on a roller or other stationary structure because the first electrode paste applied to the front side has not yet dried. Due to this lack of support, the distance between the metal foil and the second slot die and, as a result, the layer thickness can be subject to temporal fluctuations. Such variations in distance can be triggered, for example, by pressure fluctuations during the feed of the second electrode paste to the second slot die. Variations in the tensile stress of the metal foil can also affect the distance between the metal foil and the slot die. It has also been observed that thickness fluctuations of the first electrode paste on the front side of the electrode, which are tolerable in themselves, have such an unfavorable effect on the mass distribution of the electrode that they result in intolerable fluctuations in the distance between the metal foil and the second slot die.

Since the pressure generated in slot die coating systems to squeeze out the electrode pastes is built up by pumps, the slight pressure fluctuations that occur can only be avoided with great effort. Even minor fluctuations in the tensile stress in the metal foil cannot be reliably eliminated, although the movement of the metal foil past the stationary slot dies should be uniform. Drying the electrode before it is fed to the second slot die in order to be able to provide a roller or other support structure as in the first slot die is also ruled out as a measure, since this would require a second dryer and one of the essential advantages of method C would be lost.

Some aspects of the present disclosure therefore take a different approach by controlling the thickness of the second electrode paste on the rear side of the metal foil in a control loop that has a contactless thickness sensor as a control loop sensor. If the control element of the control loop is already present, the control system essentially only requires the contactless thickness sensor, which represents the control loop sensor in the control loop, in terms of hardware. With minimal additional hardware, fluctuations in the coating thickness can thus be reduced to such an extent that even tight tolerances can be maintained.

The control variable of the control loop can be, for example, a mass flow emerging from the second slot die. The easiest way to change this mass flow is by means of a pump that feeds the second electrode paste to the second slot die and then forms the actuator of the control loop. Alternatively, additional actuators can be used that are arranged near the nozzle opening of the second slot die and transiently change the pressure on the second electrode paste flowing past by small amounts or vary the mass flow of the electrode paste accordingly.

The tension (also known as the web tension) of the metal foil in the conveying direction in the area of the second slot die can also be used as the control variable for the control circuit. The greater the tension of the metal foil there, the smaller the distance to the second slot die. A less taut metal foil, on the other hand, leads to an increase in the distance. Due to this change in the distance between the second slot die and the metal foil, also the coating thickness of the second coating varies. In this case, a first actuator that exerts a tensile force on the electrode can be used as the control element of the control loop. Such an actuator can, for example, comprise a roller that engages on the front side in an area of the metal foil that was not coated during step a). This roller can be moved in a direction that is not parallel to the metal foil with the aid of actuating elements.

The position coordinate of the second slot die in the direction perpendicular to the metal foil is conceivable as another control variable. If the second slot die is movably arranged along a direction that is not parallel to the metal foil, the distance to the metal foil can be changed directly by moving the second slot die. The actuator of the control loop can then be, for example, a second actuator that moves the second slot die.

The control loop can also be configured so that several of the above-mentioned control variables are used simultaneously.

Since the electrode pastes are not transparent, it is difficult to measure the thickness of the second electrode paste on the rear side of the metal foil with a single contactless measurement. The thickness sensor therefore comprises, in one example, a first sensor unit, which measures the thickness of the electrode coated on one side, and a second sensor unit, which measures the thickness of the electrode coated on both sides. The thickness of the second electrode paste can be derived directly by calculating the difference. If the thickness sensor comprises a third sensor unit that measures the thickness of the metal foil, the thickness of the first electrode paste can be calculated by calculating the difference.

For the purpose of thickness measurement, the first and second sensor units each comprise, in one example, two distance sensors, which are arranged in pairs on opposite sides of the electrode and measure distances to the electrode. If the locations of the distance sensors assigned to each other are known, the thickness of the electrode can be directly determined from the distance values.

The distance sensors may, for example, be chromatic confocal distance sensors. Interferometric distance sensors or distance sensors that emit X-rays, beta rays, ultrasound, or thermal waves may also be used.

In battery cells, the first and second electrode pastes are usually identical. However, it is also possible to apply different electrode pastes to the opposite sides of the metal foil. The thicknesses of the two coatings may also be different.

The object mentioned at the beginning is also achieved by a device for manufacturing electrodes for battery cells, which has a first slot die that is configured to apply a first electrode paste to a front side of a metal foil. A rotatably mounted roller is configured to guide the metal foil past the first slot die so that the metal foil rests on the roller during the application of the first electrode paste. The device also has a second slot die configured to apply a second electrode paste to a rear side of the metal foil. The electrode is not supported on the front side during coating of the rear side of the metal foil. According to some aspects of the present disclosure, the device has a feedback control device, which has a contactless thickness sensor as a control loop sensor and is configured to control the thickness of the second electrode paste on the rear side of the metal foil.

The considerations and advantageous embodiments mentioned for the method apply accordingly to the device.

In particular, a control variable of the control loop can be selected from the group consisting of: a mass flow emerging from the second slot die, a tension of the metal foil in the conveying direction in the region of the second slot die, and a location coordinate of the slot die in a direction perpendicular to the metal foil.

Depending on the control variable used, an actuator of the control loop can be a pump that is configured to supply the second electrode paste to the second slot die. The pump can be used to change the flow rate. Alternatively, or additionally, an actuator of the control loop can be a first actuator that is configured to exert a pulling force on the electrode. It is also possible that an actuator of the control loop is a second actuator that is configured to move the second slot die along the direction perpendicular to the metal foil.

The thickness sensor may comprise a first sensor unit, which is configured to measure the thickness of the electrode coated on one side, and a second sensor unit, which is configured to measure the thickness of the electrode coated on both sides.

The first and second sensor units may each comprise two distance sensors arranged in pairs on opposite sides of the electrode and configured to measure distances to the electrode.

Subject of the is also a measuring and control device for use in the device described above. The measuring and control device comprises, among other things, the thickness sensor and a controller, which may also be implemented as software and is adapted for use in the device.

### BRIEF DESCRIPTION OF THE DRAWINGS

Further features and advantages of the present disclosure should be more apparent form the following description of embodiments based on the drawings, in which:

FIG. 1 a schematic and non-scale side view of a device according to the invention in accordance with a first embodiment of the present disclosure; and

FIG. 2 a top view of an electrode that is only partially covered by an electrode paste.

### DESCRIPTION OF EMBODIMENTS

### 1. First Embodiment

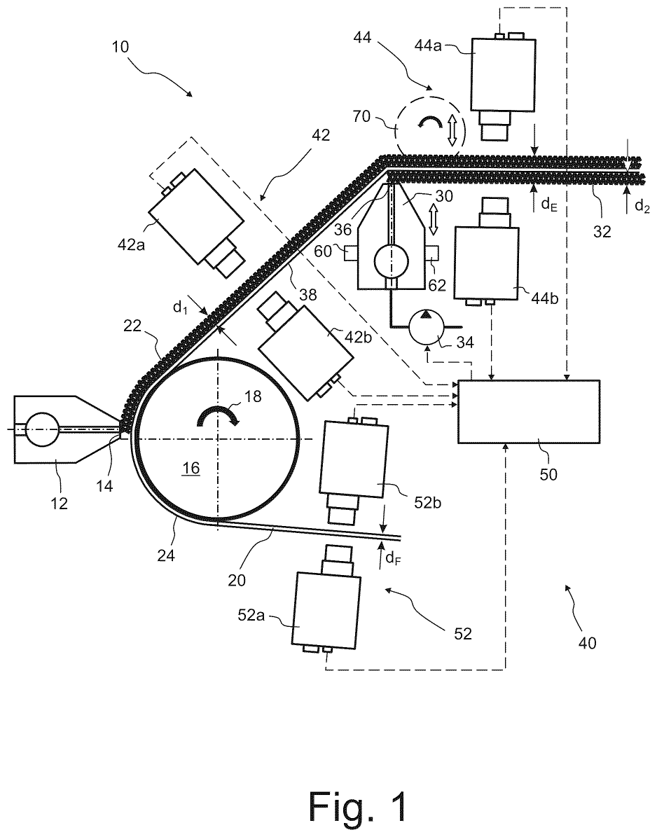

FIG. 1 shows a schematic side view of a first embodiment of a device according to the invention, designated as 10, for manufacturing electrodes for battery cells. The device 10 is designed as a slot die coating system and contains a first slot die 12, the nozzle opening 14 of which is arranged at a precisely defined distance from the surface of a roller 16. During coating, the roller 16 rotates in the direction indicated by an arrow 18 and feeds a metal foil 20, which is unwound from a storage roll not shown, to the first slot die 12.

The first slot die 12 is connected via a pump (not shown) to a reservoir (also not shown) for a first electrode paste 22, which is moist and has a granular consistency. Possible compositions for electrode pastes are described above in the description of the prior art and are also suitable for the electrode paste 22. The same applies to the metal foil 20.

The pump conveys the first electrode paste 22 from the reservoir and feeds it to the nozzle opening 14 at a constant pressure. The nozzle opening 14 is slot-shaped and extends perpendicular to the paper plane across the entire width of the metal foil 20.

The pump presses the first electrode paste 22 out of the nozzle opening 14, whereby the first electrode paste 22 is applied to the metal foil 20 and adheres there. When the rotational speed of the roller 16 and the mass flow of the first electrode paste 22 are correctly coordinated, a layer of the first electrode paste 22 with a uniform thickness d₁ is formed on the front side 24 of the metal foil 20. The thickness d₁ is determined by the distance between the nozzle opening 14 and the metal foil 20, the position of which is precisely defined by the stationary roller 16. Determined does not mean that the thickness d₁ must always be equal to this distance. Depending on the properties of the electrode paste 22, it may shrink or expand after application. In such cases, the thickness d₁ of the electrode paste 22 differs from the aforementioned distance.

A second slot die 30 is arranged behind the first slot die 12 in the conveying direction, which coats the rear side of the metal foil 20 with a second electrode paste 32. A pump 34, which supplies the second electrode paste 32 to the second slot die 30, conveys the second electrode paste from a reservoir (not shown) to a nozzle opening 36 of the second slot die 30. The mass flow of the second electrode paste 32 and the feed rate of the metal foil 20 are also coordinated here so that the rear side 38 of the metal foil 20 is coated evenly with the second electrode paste 32. However, the thickness d₂ of the electrode paste 32 on the rear side 38 varies significantly more than the thickness d₁ of the first electrode paste 22.

These greater thickness fluctuations are due to the fact that the metal foil 20 cannot be supported by a roller or similar stationary structure during coating of the rear side 38, as the first electrode paste 22 on the front side 24 has not yet dried and must therefore not be touched. The distance between the metal foil 20 and the nozzle opening 36 of the second support nozzle 30 is therefore not precisely defined during the coating of the rear side 38, which leads to the undesirable thickness fluctuations.

In order to avoid such thickness fluctuations or at least reduce them to a tolerable level, the device 10 has a measuring and control device 40, which, together with the control system described above, forms a control loop.

For this purpose, the measuring and control device 40 comprises a thickness sensor with which the thickness of the second electrode paste 32 applied to the rear side 38 of the metal foil 20 can be measured without contact. In the embodiment shown, the thickness sensor comprises a first sensor unit 42 and a second sensor unit 44, each of which has a pair of opposing distance sensors 42a, 42b and 44a, 44b, respectively.

The distance between the distance sensors 42a, 42b is known with high accuracy, so that the thickness of the single-sided coated electrode passing between them can be derived from the distances measured by the distance sensors 42a, 42b. This thickness is obtained from the distance between the distance sensors 42a, 42b minus the measured distances to the surface of the first electrode paste 22 and to the rear side 38 of the metal foil 20, respectively. In this way, the first sensor unit 42 can measure the thickness of the single-sided coated electrode quasi-continuously while the single-sided coated electrode is guided between the distance sensors 42a, 42b. Chromatic confocal distance sensors, which have a very high measuring accuracy at sampling rates of around 35 kHz, are suitable as distance sensors 42 a, 42 b.

In the case of very wide metal foils 20, the distance sensors 42a, 42b can also be configured as line sensors, or several point-measuring distance sensors can be arranged next to each other along a direction perpendicular to the paper direction. However, greater thickness fluctuations often occur only in the longitudinal direction of the electrode and not in the transverse direction, so that a single pair of point-measuring distance sensors 42a, 42b may be sufficient.

The second sensor unit 44 with the distance sensors 44a, 44b is constructed in the same way and thus provides the thickness d_{E} of the electrode coated on both sides at this point.

The thickness d₂ of the second electrode paste 32 on the rear side 38 of the metal foil 20 can be determined by subtracting the thickness of the electrode coated on one side, which is measured by the first sensor unit 42, from the thickness d_{E} of the electrode coated on both sides, which is measured by the second sensor unit 44.

If the thickness of the first electrode paste 22 is sufficiently constant, the measurement data generated by the sensor units 42, 44 do not need to be correlated in time. If this assumption is not fulfilled, the thicknesses measured by the sensor units 42, 44 must be synchronized accordingly via the feed speed of the metal foil 20 (“same spot measurement”).

The calculation of the thickness d₂ of the second electrode paste 32 described above is performed in a controller 50, to which the measurement data from the distance sensors 42a, 42b and 44a, 44b are fed. If the measured actual value of the thickness d₂ deviates noticeably from a predetermined target value, the controller 50 calculates a control variable for an actuator that ensures a reduction in the thickness deviation.

In the embodiment shown, the actuator is the pump 34, which supplies the second electrode paste 32 to the second slot die 30. If, for example, the measured actual value of the thickness of the second electrode paste 32 is below the target value, the pump 34 is controlled so that it delivers more mass, thereby increasing the mass of the second electrode paste 32 emerging from the slot die 30 per unit of time and thus increasing the thickness. If, on the other hand, the thickness sensor detects that the target thickness has been exceeded, the pump output of pump 34 is reduced accordingly by the controller 50. The control ensures that the second electrode paste 32 is applied with a uniform thickness d₂ despite the lack of support on the front side of the metal foil 20.

In the embodiment shown, the device 10 also contains a third sensor unit 52, which likewise comprises a pair of opposing distance sensors 52a, 52b. The third sensor unit 52 measures the thickness d_{F} of the metal foil 20 before the front side 24 is coated by the first slot die 12. This makes it possible to measure the thickness d₁ of the layer of first electrode paste 22 applied to the front side 24 by calculating the difference. Generally, it is not necessary to control the thickness d₁. However, tolerable fluctuations in the thickness d₁ of the first electrode paste 22 can affect the coating with the second electrode paste 32 due to the associated mass shifts. The controller 50 can take fluctuations in the thickness d₁ into account when determining the control variable for the pump 34.

### 2. Further Embodiments

Actuators are indicated in FIG. 1 at 60 and 62, which can be used to move the second slot die 30 at least approximately perpendicular to the metal foil 20 over short distances. In this way, the distance between the metal foil and the nozzle opening 36 of the second slot die 30 and thus the layer thickness of the second electrode paste 32 can be varied. The actuators 60, 62 represent control elements of the control loop with which the controller 50 can act on the thickness d₂. These control elements can be provided in addition to or as an alternative to the pump 34.

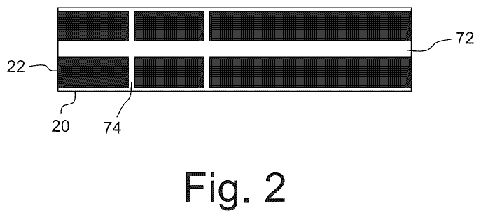

Another possible actuator is indicated in FIG. 1 by a dotted roller 70, which can be moved by actuating elements not shown, as indicated by a double arrow. Such a roller 70 may only touch the electrode in areas where no electrode paste covers the metal foil 20. Such uncovered and mostly strip-shaped areas are shown in FIG. 2 in a top view and designated 72 (longitudinal strips) and 74 (transverse strips). The roller 70 can engage with the longitudinal strip 72 extending in the longitudinal direction of the electrode, thereby generating a tensile stress in the metal foil 20. In order to change the tensile stress, the actuating elements move the roller 70, causing it to move slightly toward or away from the metal foil 20. The roller 70 thus acts as an actuator that exerts a tensile force on the metal foil 20. The tensile force changes the tensile stress in the metal foil and thus the distance between the metal foil 20 and the nozzle opening 36 of the second slot die 30. This change in distance has a direct effect on the layer thickness of the second electrode paste 32.

In general, it is sufficient for the controller 50 to act on only one of the actuators mentioned. In principle, however, it is also possible to provide several different actuators.

What is claimed is:

1-17. (canceled)

18. A method for manufacturing electrodes for battery cells, the method comprising the steps of:
a) guiding a metal foil, lying on a rotating roller, past a first slot die from which a first electrode paste is discharged, thereby coating a front side of the metal foil with the first electrode paste; and
b) guiding the metal foil, without drying the first electrode paste, past a second slot die from which a second electrode paste is discharged, thereby coating a rear side of the metal foil with the second electrode paste, without the metal foil being supported by a stationary structure,
wherein a thickness of the second electrode paste on the rear side of the metal foil is controlled in a feedback control loop that includes a contactless thickness sensor as a control loop sensor.

19. The method of claim 18, wherein a control variable of the feedback control loop is selected from the group consisting of: a mass flow discharged from the second slot die; a tension of the metal foil in a conveying direction in a region of the second slot die; and a position coordinate of the second slot die in a direction perpendicular to the metal foil.

20. The method of claim 19, wherein the control variable is the mass flow discharged from the second slot die, and wherein an actuator of the feedback control loop is a pump that supplies the second electrode paste to the second slot die.

21. The method of claim 19, wherein the control variable is the tension of the metal foil in the conveying direction in the region of the second slot die, and wherein an actuator of the feedback control loop is a first actuator that exerts a tensile force on the electrode.

22. The method of claim 21, wherein the first actuator comprises a roller that engages on the front side in a region of the metal foil that was not coated during step a).

23. The method of claim 18, wherein the contactless thickness sensor comprises a first sensor unit that measures a thickness of the electrode coated on one side of the metal foil, and a second sensor unit that measures a thickness of the electrode coated on both sides of the metal foil.

24. The method of claim 23, wherein the first and second sensor units each comprise two distance sensors that are arranged in pairs on opposite sides of the electrode and that measure distances to the electrode.

25. The method of claim 24, wherein the distance sensors are chromatic confocal measuring distance sensors.

26. The method of claim 24, wherein the distance sensors are interferometrically measuring distance sensors.

27. The method of claim 18, further comprising using a contactless thickness sensor for measuring the thickness of the second electrode paste on the rear side of the metal foil.

28. A device for manufacturing electrodes for battery cells, the device comprising:
a first slot die configured to apply a first electrode paste to a front side of a metal foil;
a rotatably mounted roller configured to guide the metal foil past the first slot die so that the metal foil rests on the roller during application of the first electrode paste;
a second slot die configured to apply a second electrode paste to a rear side of the metal foil, wherein the electrode is not supported on the front side during application of the second electrode paste to the rear side of the metal foil; and
a feedback control device configured to control a feedback control loop, wherein the feedback control device includes a contactless thickness sensor as a control loop sensor and is configured to control the thickness of the second electrode paste on the rear side of the metal foil.

29. The device of claim 28, wherein a control variable of the feedback control device is selected from the group consisting of: a mass flow discharged from the second slot die; a tension of the metal foil in a conveying direction in a region of the second slot die; and a position coordinate of the second slot die in a direction perpendicular to the metal foil.

30. The device of claim 28, wherein the thickness sensor comprises a first sensor unit configured to measure a thickness of the electrode coated on one side of the metal foil, and a second sensor unit configured to measure a thickness of the electrode coated on both sides of the metal foil.

31. The device of claim 30, wherein the first and second sensor units each comprise two distance sensors that are arranged in pairs on opposite sides of the electrode and that are configured to measure distances to the electrode.

32. The device of claim 31, wherein the distance sensors are chromatic confocal measuring distance sensors.

33. The device of claim 31, wherein the distance sensors are interferometric measuring distance sensors.

34. The device of claim 28, further comprising a measuring and control device for use therein.

35. A device for manufacturing electrodes for battery cells, the device comprising:
a first slot die configured to apply a first electrode paste to a front side of a metal foil;
a second slot die configured to apply a second electrode paste to a rear side of the metal foil;
a feedback control device that controls a feedback control loop, that includes a contactless thickness sensor as a control loop sensor, and that is configured to control the thickness of the second electrode paste on the rear side of the metal foil; and
an actuator that is part of the control loop and is configured to exert a tensile force on the electrode.

36. The device of claim 35, wherein the contactless thickness sensor comprises a first sensor unit configured to measure a thickness of the electrode coated on one side of the metal foil, and a second sensor unit configured to measure a thickness of the electrode coated on both sides of the metal foil.

37. The device of claim 36, wherein the first and second sensor units each comprise two distance sensors that are arranged in pairs on opposite sides of the electrode and that are configured to measure distances to the electrode.
